(19) United States
(12) Patent Application Publication
(10) Pub. No.: US 2024/0220813 A1
(43) Pub. Date: Jul. 4, 2024

(54) REDUCING BIAS IN VISUAL SPEECH RECOGNITION

(71) Applicant: Technology Innovation Institute - Sole Proprietorship LLC, Masdar City (AE)

(72) Inventors: Kebin Wu, Masdar City (AE); Elena-Ruxandra Cojocaru, Masdar City (AE); Ebtesam Almazrouei, Masdar City (AE)

(73) Assignee: Technology Innovation Institute - Sole Proprietorship LLC, Masdar City (AE)

(21) Appl. No.: 18/149,476

(22) Filed: Jan. 3, 2023

(51) Int. Cl. G06N 3/094; G06F 18/15

(52) U.S. Cl. CPC G06N 3/094; G06F 18/15

(57) ABSTRACT

Systems, methods, and computer-readable media for reducing a bias in visual speech recognition (VSR). In the present embodiments, a comprehensive analysis of the bias (e.g., determining type and severity of the bias) can be performed for each sample in the training data, such as age, gender, and ethnicity, for example. Further, synthetic training data can be generated for under-represented groups using various techniques, such as generative adversarial networks (GANs), for example. Additionally, synthetic video generation can be performed using different modes (e.g., six modes) to ensure quantities and diversity in the synthetic samples. A combination of the real data and the synthetic training data generated can be used to train a VSR model.

### TECHNICAL FIELD

This disclosure relates to systems, methods, and computer-readable media for identifying under-represented groups in training data and generating synthetic samples for training a visual speech recognition (VSR) model.

### BACKGROUND

Visual speech recognition (VSR) or automated lip-reading aims to decode content of speech from a soundless video using various artificial intelligence (AI) technologies. In many cases, a computing node (or series of interconnected computing nodes) can utilize one or more sets of training data to train model(s) (such as a VSR model) to implement a VSR system capable of decoding content of speech in a soundless video.

The training set of data can include multiple recorded and/or synthetically generated sources of content (e.g., soundless videos) with corresponding speech for each source of content. The training set of data can include sources of content from various groups of individuals (or synthetically-generated representations of individuals), such as a group defined by age, gender, cultural background, and/or whether the individual is a native speaker or non-native speaker of a language.

### SUMMARY

The present embodiments relate to systems, methods, and computer-readable media for generating synthetic samples for training a visual speech recognition (VSR) model. A set of training data can be processed based on different classification criteria to identify groups in which each sample in the training data corresponds. Further, a plurality of synthetic samples can be generated by another model (e.g., a GAN model) for use in supplementing the training data with additional samples that can reduce any bias in the VSR model toward under-represented groups. The real data and the synthetic samples together can be used to train a VSR model to identify speech content in a live sample with increased accuracy.

In a first example embodiment, a method is provided. The method can include obtaining a set of training data configured to train the VSR model. The set of training data can include a series of samples, with each sample providing video of a subject and corresponding text specifying speech content (and, in some cases, audio). For example, a sample can include a video depiction of a subject speaking. Further, the sample can include text speech content text (and, in some cases, audio), for use in training the VSR model.

The method can also include deriving, for each sample included in the set of training data, a number of groups in which the sample corresponds. In some instances, each group is associated with a corresponding group type. Each group type can relate to any of: a predicted age, gender, with/without beard or moustache, accent, ethnicity and/or other attributes of a subject depicted in each sample.

In some instances, deriving each group in which each sample corresponds further comprises: processing each sample with any of an age estimation model, a gender classification model, and a cultural background prediction model to predict a series of attributes of the sample. The series of attributes can be used in deriving each group in which the sample corresponds.

The method can also include identifying, for each group, whether the group is an under-represented group based on a determination of whether the group is associated with fewer samples than an amount of samples associated with other groups of a same group type.

In some instances, identifying whether the group is the under-represented group further includes: performing a histogram analysis to determine each under-represented group as being associated with fewer samples than the amount of samples associated with other groups of the same group type.

The method can also include generating, by a sample generation model, a plurality of synthetic samples. The synthetic samples can include features associated with one or more identified under-represented groups, and wherein the plurality of synthetic samples to be generated for each under-represented group is determined based on a difference between samples associated with the under-represented group and the samples that are associated with the other groups of the same group type.

In some instances, the sample generation model is a generative adversarial network (GAN) model. In some instances, generating synthetic samples further comprises: implementing a random latent vector with any of a series of conditional signals (or input data) as an input to the GAN model for generating each synthetic sample. In some instances, the set of input data comprises any of: a face image and audio associated with the first group; a mouth area image and the audio associated with the first group; the face image and a natural language text associated with the first group; the mouth area image and the natural language texts associated with the first group; the face image and a text-audio pair associated with the first group; and the mouth area image and the text-audio pair associated with the first group.

The method can also include training the VSR model using the set of training data including the synthetic samples generated by the sample generation model. The VSR can be configured to derive speech content from a video input.

This Summary is provided to summarize some example embodiments, so as to provide a basic understanding of some aspects of the subject matter described in this document. Accordingly, it will be appreciated that the features described in this Summary are merely examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The above and other aspects of the disclosure, its nature, and various features will become more apparent upon consideration of the following detailed description, taken in conjunction with the accompanying drawings, in which like reference characters may refer to like parts throughout, and in which:

FIG. 1 is a flow process of a method for training a VSR model using both training data including real samples and synthetic samples for one or more under-represented groups according to an embodiment.

FIG. 2 illustrates an example flow process for classifying groups for each sample included in a set of training data according to an embodiment.

FIG. 3 is an example flow process for generating a synthetic sample according to an embodiment.

FIG. 4 is a flow process for training a VSR model using training data including real samples and synthetic samples generated by a sample generation model according to an embodiment.

FIG. 5 is a flow process of an example method for generating synthetic samples for training a visual speech recognition (VSR) model according to an embodiment.

FIG. 6 illustrates an example system for identifying under-represented groups (URGs) and generating synthetic samples for training a VSR model according to an embodiment.

FIG. 7 is a block diagram of a special-purpose computer system according to an embodiment.

### DETAILED DESCRIPTION

Visual speech recognition (VSR) or automated lip-reading aims to decode content of speech from a soundless video using various artificial intelligence (AI) techniques. Further, training data can be used to train model(s) (such as a VSR model) to implement a VSR system capable of decoding content of speech in a soundless video.

However, in many instances, the amount of samples across groups may be uneven. For example, a majority of samples in the training data can include individuals in a first age group (e.g., 18-30 years), while other groups (e.g., under 18, above 70 years) may either not be represented at all or may include fewer samples than the first age group. As another example, the amount of female speakers may be significantly less than male speakers in the training data. Such groups may be referred to as “under-represented groups (URGs).”

Training data that includes such discrepancies across groups may result in reduced accuracy in the VSR model identifying content in speech, particularly when the individual is part of any under-represented group. For example, an important feature in VSR is to accurately interpret lip movement. However, lip movement may not be entirely decided by the speech content since lip-movement for the same speech can vary with gender, age, culture etc. Accordingly, in training a VSR model with training data that includes under-represented groups, the VSR model may be unable to accurately interpret lip movement and the content of the speech of the speaker.

As another example, age can be a particularly crucial factor in varying facial features that affect VSR. For instance, 1- and 2-year-old children's upper and lower lip movements may be more variable when compared with adults. Furthermore, lip displacement signals can be normalized, and a spatio-temporal index (STI) can be proposed representing individual variability in the movement pattern. This can indicate that STI for older adults may be significantly higher (more variables), and speech durations were longer than those of young adults. For example, as an individual ages, the variability of lip movements across repetitions of the same utterance can decrease.

Further, in terms of gender, lips and lip movement can be different from male to female individuals. For instance, there may be significant gender differences in the lip-closing force (LCF) generated during pursing-like lip-closing movement. In some instances, gender can be distinguished with high accuracy based on the lip movement sequence.

Accordingly, it can be highly likely that the performance of VSR model trained using over-represented groups (e.g., young/middle aged male adults) can degrade when it is used for other age groups or gender. In fact, a similar problem can be reported for speech recognition, where, for example, recognizing children's speech can be more challenging as their vocal cords are still developing, they have a lower speaking rate but more spontaneity, and tend to use a different vocabulary compared to adults.

In summary, training data that includes under-represented groups can lead to decreased accuracy of the VSR model. Without modifying and/or generating training data to reduce such a bias, a trained VSR model can be inaccurate (or show a bias) with subjects that are part of certain groups. The present embodiments relate to systems and computer-implemented methods to reduce the bias in VSR. In the present embodiments, a comprehensive analysis of the bias (e.g., determining type and severity of the bias) can be performed for each sample in the training data, such as age, gender, and ethnicity, for example. Further, synthetic training data can be generated for under-represented groups using various techniques, such as generative adversarial networks (GANs), for example. Additionally, synthetic video generation can be performed using different modes (e.g., six modes) to ensure quantities and diversity in the synthetic samples.

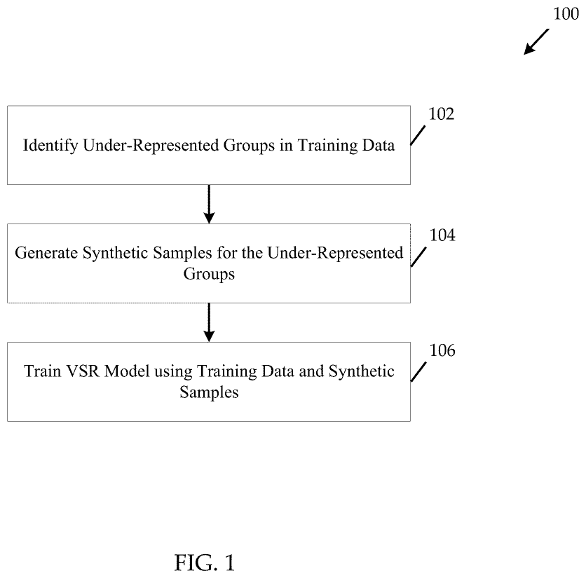

FIG. 1 is a flow process 100 of a method for training a VSR model using both real data and synthetic samples for one or more under-represented groups. The method as described in FIG. 1 can be performed by a computing node or a series of interconnected computing nodes as described herein.

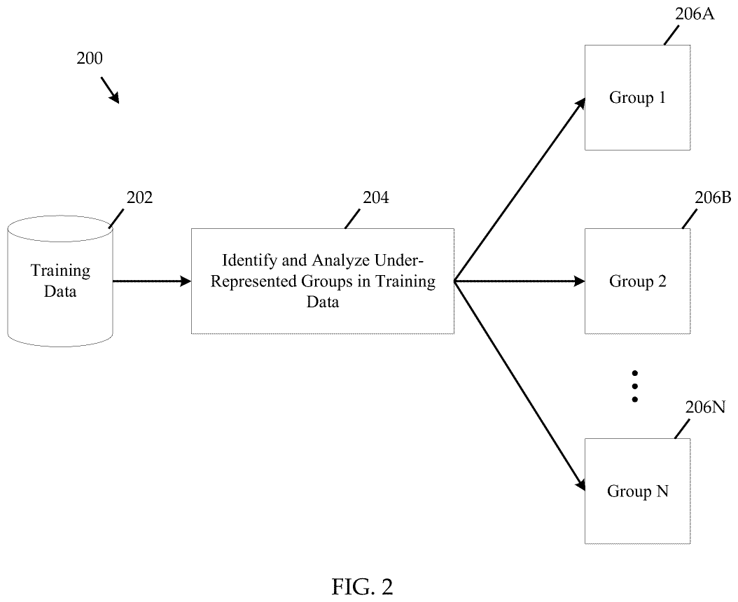

As shown in FIG. 1, at 102, the method can include identifying under-represented groups in training data. This can include processing each sample in the training data to predict each group in which a sample is included. For example, a sample can be processed to determine that the subject depicted in the sample is predicted to be part of a first age group (e.g., 18-30 years old), a gender group (e.g., female), native/non-native speaker group (e.g., native speaker), etc. After processing each sample, each under-represented group (URG) can be determined based on the number of samples that are part of each group relative to similar group types. For example, it can be determined that an age group of 60+ years old is less represented (e.g., has fewer samples) than a similar group type (e.g., a group of subjects that are 18-30 years old). Identifying under-represented groups in training data is described in greater detail with respect to FIG. 2.

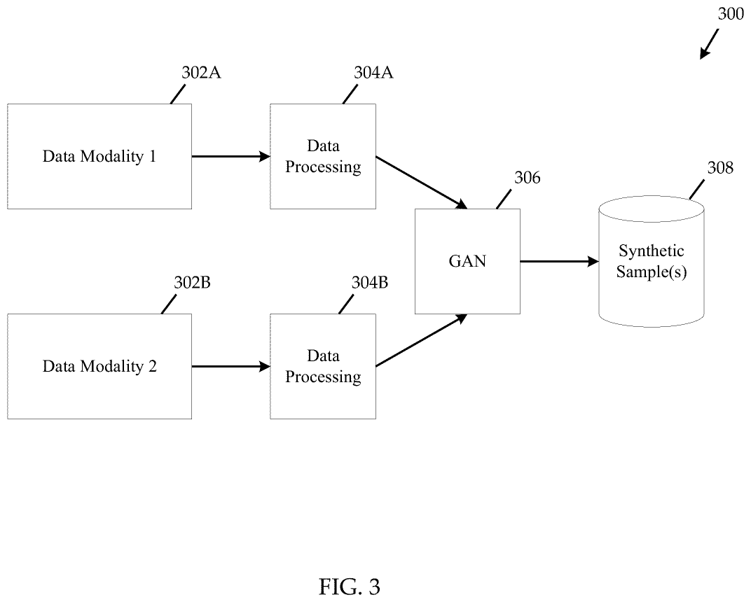

At 104, the method can include generating synthetic samples for the under-represented groups. The computing node can implement a model (e.g., a GAN) to generate synthetic samples that are part of any of the specified URGs. In some instances, six input modes can be used to generate a synthetic sample that comprises a talking video output of a computer-generated sample subject. Generating synthetic samples for the under-represented groups is described in greater detail with respect to FIG. 3.

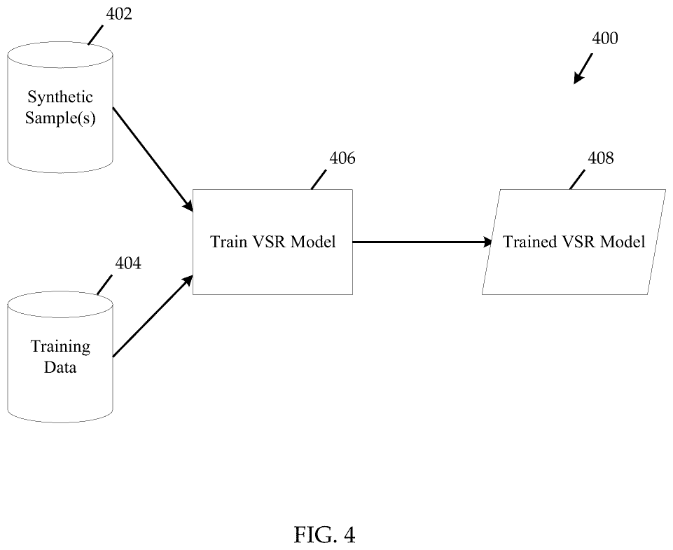

At 106, the method can include training a VSR model using training data including real samples and synthetic samples. The combination of the real data and the synthetic samples can increase training data that accounts for any URGs in the training data, resulting in a more accurate performance of the VSR model. Training the VSR model using the training data that includes real samples and generated synthetic samples is described in greater detail with respect to FIG. 4.

### Identifying Under-Represented Groups (URGs) in Training Data

As described above, the training data used to train a VSR model can include video as well as the speech text (and, in some cases, audio). The training data can be used by the VSR model to correlate facial features and movements of the subject with corresponding speech.

FIG. 2 illustrates an example flow process 200 for classifying groups for each sample included in a set of training data. As shown in FIG. 2, a set of training data 202 can be provided. The training data 202 can include a series of samples, with each sample comprising video, speech text of a subject speaking, and in some cases, audio.

In many instances, a number of group types can be identified. The group types can be specified based on common factors that impact speech and/or lip reading, such as age, gender, ethnicity, accent, and having a beard or moustache, for example. Each group type can be broken into groups, such as age ranges for a group type specifying age.

At 204, the under-represented groups can be identified and analyzed in the training data. This can include processing each sample to predict a group in which each sample is included. For example, any of an age estimation, gender classification, and ethnicity prediction model can be implemented to process each sample to determine groups for the sample. After processing a sample, the sample can be specified as being part of each corresponding group (e.g., groups 206A-N).

Further, attributes can be extracted for each sample by analyzing the video and audio (if available) for each sample. For example, based on the face image in the video, audio, or video-audio pair, attributes can be predicted, such as age, gender, and ethnicity. The attributes can be determined using age estimation, gender classification, and ethnicity prediction models. In some instances, accent meta information can be obtained by using accent classification on speech. For beards, face attribute analysis on the video can offer the result. In some embodiments, multiple frames in the video can be processed to get more accurate estimations on attributes for each sample.

With regards to age, one or more machine learning models can be trained after extracting facial features (e.g., wrinkles and skin status) and/or audio feature (e.g., fluctuation of pitch and amplitude), leading to predictions with high accuracy. Further, with gender estimation, a classification model can capture discriminative facial features such as skeleton, eyebrow, and the existence of beard/moustache. In addition, another recognition model can exploit audio features such as pitch to further enhance classification accuracy.

For each listed attribute, a histogram analysis can be performed on a given dataset. For example, based on the histogram, the under-represented groups (all groups except for the group with largest number) and a needed sample number (difference between the size of most represented group and the size of the current group) can be identified. For instance, for a specified attribute (e.g., age), several categorical groups are defined according to preset rules. As an example, a young group can include an age range between 18 and 30, and an old group with an age range greater than 60. A histogram can be calculated by counting the occurrence of each group (e.g., young) in the training set. The histogram can provide the statistical sample size for each group that is associated with the specified attribute.

Groups can be analyzed based on a group type to identify both whether a group is a URG and/or the number of samples to even the group based on other groups of the same group type. The result can include specifying each URG and the number of samples to even each URG in comparison to similar groups of the group type.

### Synthetic Sample Generation

As described above, a plurality of synthetic samples can be generated to account for URGs identified in the training data. For each under-represented group, a conditional GAN can be trained and then used later to generate various synthetic samples (e.g., talking videos). The conditional GAN can include both a generator and a discriminator.

In order to train a generator, one method can be to train it together with a discriminator. Such training approach can help to get a good generator. Further, when the training is finished, the discriminator may no longer be needed. At the inference stage, the system can only use the trained generator to generate synthetic samples. Any generated samples with the generator can be regarded as realistic.

To generate samples for a certain URG (e.g., female), the system can train multiple generators, depending on the modes used, with face and audio combination as an example. When the trained generator(s) are used to generate samples, the system can use two kinds of input: (a) a random vector; (b) multiple data (one of the 6 combination, depending on what kinds of data the generator was trained on). Such data however may not come from VSR training data, but rather from other sources of data, such as face image database (female) and audio database (female).

FIG. 3 is an example flow process 300 for generating a synthetic sample. As shown in FIG. 3, a number of data modality instances 302A-B can be provided for data processing (e.g., 304A-B). For instance, a first data modality for a group can include an image, and a second data modality for the group can include audio. The processed data can be provided to a GAN 306 for generating a synthetic sample 308.

For example, for a URG (G₁), a conditional GAN can take a random latent vector together with the conditional signal(s) (or input data) as an input. There can be 6 different modes for the conditional signals: (1) Face image and audio corresponding to G₁; (2) Mouth area image and audio corresponding to G₁; (3) Face image and natural language texts corresponding to G₁; (4) Mouth area image and natural language texts corresponding to G₁; (5) Face image and text-audio pair corresponding to G₁; (6) Mouth area image and text-audio pair corresponding to G₁.

In some instances, a first combination (i.e., face and audio) can be used as an example. Let V_{R}={s₁, s₂, . . . , s_{Tv}} be the sequence of the video frames for a real video from G₁, A={a₁, a₂, . . . , a_{Ta}} be the sequence of waveform segments of its audio, and I the face image in s₁. In this example, the audio is enframed into different segments by using a sliding window. During the training of the conditional GAN, the generator can output a new video V_{F} given I and A, with the purpose of deceiving the discriminator that the generated video is a real video. The discriminator, on the contrary, can have the role to discriminate between the real video V_{R} and the generated video V_{F}. The generator and discriminator can be trained alternatively via an optimization strategy, such as a min-max technique. When the model training reaches convergence, the discriminator can be discarded, and the generator can be kept for the inference stage. Given a random latent vector, an audio sequence from G₁, and a face image from G₁ (note that the audio sequence and face image do not have to be from the same subject), the trained generator can output a talking video for G₁.

In some instances, in the training, the sequence lengths of video and audio do not have to be the same. If they are not the same, another block can be added at the end of the generator, which can include a layer of interpolation or full connection. The number of generated talking videos for each group can be equal to the needed samples number, which can be obtained after performing a histogram analysis as described above. During training, the audio and face image used for conditional signals can be from real datasets. However, the quantities for such signals may be much larger than that of video, guaranteeing the richness of the generated talking video. The generator and discriminator in the conditional GAN can be able to capture the within sequence relationship. In some instances, the structure of the model can include any of a transformer, a long short-term memory (LSTM), and a recurrent neural network (RNN).

### VSR Model Training

As noted above, a VSR model can be trained using training data in order to derive speech content in a live input comprising a video of a subject speaking without audio. However, if the training data includes URGs, the accuracy in the trained VSR model can decrease, particularly if a subject in the live input is part of one or more URGs. Accordingly, the present embodiments include training the VSR model with training data including both real and synthetic samples generated by a GAN, as noted above. The synthetic samples can provide samples representing features specific to the URGs in the training data. The training dataset, which are then augmented with the synthetic samples, can improve the accuracy of the trained VSR model.

FIG. 4 is a flow process 400 for training a VSR model using training data including the synthetic samples generated by a sample generation model. As shown in FIG. 4, training data 404 can include synthetic samples 402 and can be used to train the VSR model 406. Training the VSR model can include using the training data with the synthetic samples as an input to derive features from each sample in order to correlate speech from video depicting a subject speaking. After training (e.g., at 406), a trained VSR model 408 can be provided. The trained VSR model can be used to derive speech text given a soundless video.

For instance, the original training data can be denoted (real video only) as DS_{raw}, and the VSR model trained on DS_{raw} as M_{raw}. Various synthetic videos can be generated for all under-represented groups. After adding them to the original training data DS_{raw}, a new dataset can be generated, denoted as DS_{new}. In some instances, the sample size for each group can be balanced. Finally, based on the new dataset DS_{new}, another VSR model M_{new} can be trained by following the same training scheme used for M_{raw}. By utilizing the evaluation metrics for VSR such as WER (word error rate), the performance of M_{new} and M_{raw} can be compared on real testing datasets, especially for the minority groups.

As described above, the present embodiments can boost VSR accuracy, especially for languages other than English where less training data is generally available and where specific groups could be under-represented due to privacy or cultural concerns that might hinder filming individuals who belong to those groups.

### Example Method for Generating Synthetic Samples for Training a VSR Model

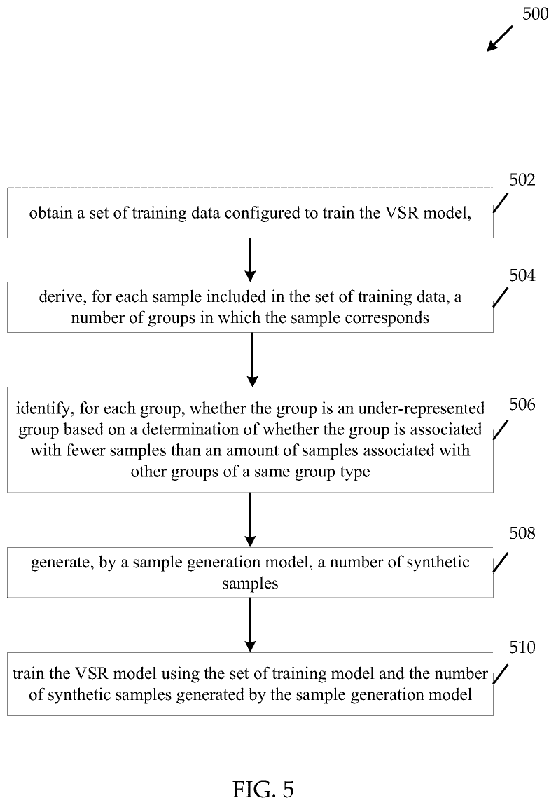

FIG. 5 is a flow process of an example method 500 for generating synthetic samples for training a visual speech recognition (VSR) model. At 502, the method can include obtaining a set of training data configured to train the VSR model. The set of training data can include a series of samples, with each sample providing video of a subject and corresponding and/or text (and, in some cases, audio) specifying speech content. For example, a sample can include a video depiction of a subject speaking. Further, the sample can include audio and/or text speech content for use in training the VSR model.

At 504, the method can include deriving, for each sample included in the set of training data, a number of groups in which the sample corresponds. In some instances, each group is associated with a corresponding group type. Each group type can relate to any of: a predicted age, gender, with/without beard or moustache, accent, ethnicity, and/or other attributes (that may affect VSR) of a subject depicted in each sample

In some instances, deriving each group in which each sample corresponds further comprises processing each sample with any of an age estimation model, a gender classification model, and a cultural background prediction model to predict a series of attributes of the sample. The series of attributes can be used in deriving each group in which the sample corresponds.

At 506, the method can include identifying, for each group, whether the group is an under-represented group based on a determination of whether the group is associated with fewer samples than an amount of samples associated with other groups of a same group type.

In some instances, identifying whether the group is the under-represented group further includes: performing a histogram analysis to determine each under-represented group as being associated with fewer samples than the amount of samples associated with other groups of the same group type.

At 508, the method can include generating, by a sample generation model, a plurality of synthetic samples. The synthetic samples can be associated with one or more identified under-represented groups, and wherein the plurality of synthetic samples to be generated for each under-represented group is determined based on a difference between samples associated with the under-represented group and the samples that are associated with the other groups of the same group type.

In some instances, the sample generation model is a generative adversarial network (GAN) model. In some instances, generating synthetic samples further comprises: implementing a random latent vector with any of a series of conditional signals as an input to the GAN model for generating each synthetic sample. In some instances, the series of conditional signals comprise any of: a face image and audio associated with a first group (e.g., an under-represented group); a mouth area image and the audio associated with the first group; the face image and a natural language texts associated with the first group; the mouth area image and the natural language texts associated with the first group; the face image and a text-audio pair associated with the first group; and the mouth area image and the text-audio pair associated with the first group.

At 510, the method can include training the VSR model using the set of real data and the synthetic samples generated by the sample generation model. The VSR can be configured to derive speech content from a video input.

### Computing System Overview

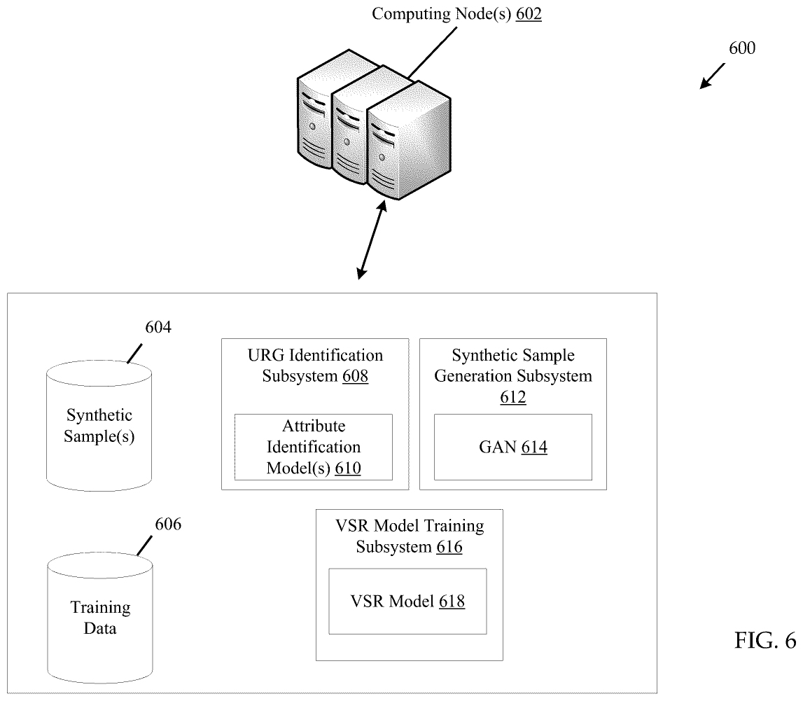

As described above, a computing node (or series of interconnected computing nodes) can identify URGs and generate synthetic samples for training a VSR model as described herein. FIG. 6 illustrates an example system 600 for identifying URGs and generating synthetic samples for training a VSR model.

As shown in FIG. 6, the system 600 can include a computing node (or series of interconnected computing nodes) 602. Further, the computing node 602 can store various data and include subsystems as described herein. For instance, the computing node 602 can store synthetic samples 604 generated by a synthetic sample generation subsystem 612 and real training data 606 for training the VSR model 618.

Further, the computing node 602 can implement a URG identification subsystem 608. The URG identification subsystem 608 can be configured to specify a number of groups, with each group associated with a group type (e.g., age, gender, accent, ethnicity, facial hair). Further, the URG identification subsystem 608 can also be configured to process each sample in the training data and identify each group in which the sample belongs.

The URG identification subsystem 608 can implement one or more attribute identification models 610 to identify attributes of each sample that are used to classify cach sample into one or more groups. For example, each sample can be processed with any of an age estimation model, a gender classification model, and a cultural background prediction model to predict a series of attributes of the sample. Each of these models can process the sample and predict a likely classification of the sample based on the derived attributes. For example, an age estimation model can process facial (and audio, if available) features of the sample and predict an age of the subject depicted in the sample, which can be used to classify the sample into an age group. As another example, the gender classification model can process facial (and audio, if available) features of the sample and predict a gender of the subject depicted in the sample. Further, a cultural background prediction model can process the facial (and audio, if available) features to predict a cultural background (or ethnicity) of the speaker. Such attributes can be used to classify each sample into groups and identify URGs as described herein.

The computing node 602 can also include a synthetic sample generation subsystem 612. The sample generation subsystem 612 can identify a number of samples to be generated and can generate synthetic samples as described herein. For instance, the plurality of synthetic samples to be generated for each under-represented group can be determined based on a difference between samples associated with the under-represented group and the samples that are associated with the other groups of the same group type.

As an example, for a first group type (e.g., age), a first group (e.g., 18-30) can be represented in ten samples in the training set, while a second group (e.g., over 65 years old) is represented only five times in the training set. Such a discrepancy (e.g., five samples) between the first group and the second group of the same group type can indicate that the second group is an under-represented group (URG). In response, a number of new samples (e.g., five) can be generated to account for the discrepancy in the URG. In some instances, a histogram analysis is performed to determine each under-represented group as being associated with fewer samples than the amount of samples associated with other groups of the same group type.

The sample generation subsystem 612 can implement a model (e.g., a GAN 614) to generate the synthetic samples. The GAN 14 can implement a random latent vector with any of a series of conditional signals as an input to the GAN model for generating each synthetic sample. The series of conditional signals can comprise any of: a face image and audio associated with a first group (e.g., an under-represented group); a mouth area image and the audio associated with the first group; the face image and a natural language texts associated with the first group; the mouth area image and the natural language texts associated with the first group; the face image and a text-audio pair associated with the first group; and the mouth area image and the text-audio pair associated with the first group.

The computing node 602 can also include a VSR model training subsystem 616. The VSR model training subsystem 616 can use the training data 606 including synthetic samples 604 to train a VSR model 618 with greater accuracy than the training data without the synthetic samples.

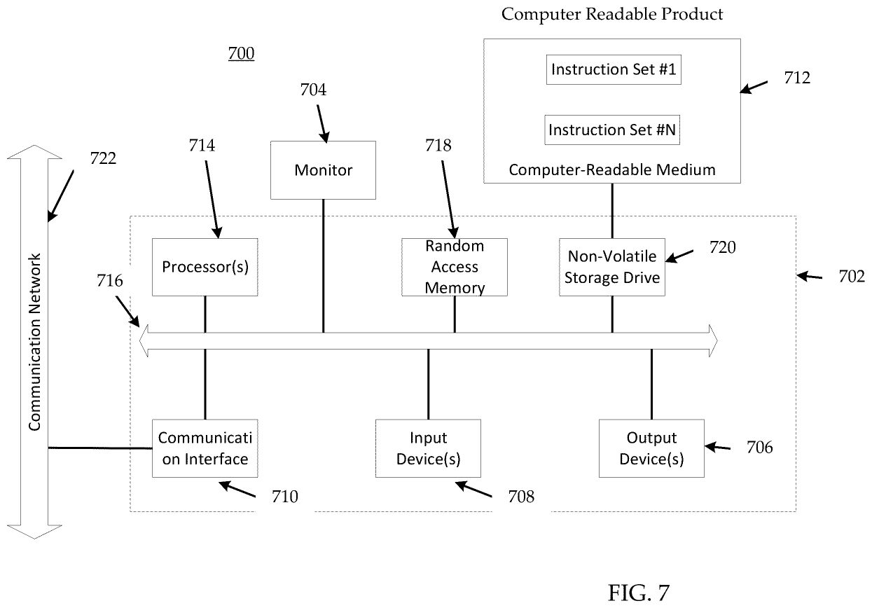

FIG. 7 is a block diagram of a special-purpose computer system 700 according to an embodiment. The methods and processes described herein may similarly be implemented by tangible, non-transitory computer readable storage mediums and/or computer-program products that direct a computer system to perform the actions of the methods and processes described herein. Each such computer-program product may comprise sets of instructions (e.g., codes) embodied on a computer-readable medium that directs the processor of a computer system to perform corresponding operations. The instructions may be configured to run in sequential order, or in parallel (such as under different processing threads), or in a combination thereof.

Special-purpose computer system 700 comprises a computer 702, a monitor 704 coupled to computer 702, one or more additional user output devices 706 (optional) coupled to computer 702, one or more user input devices 708 (e.g., keyboard, mouse, track ball, touch screen) coupled to computer 702, an optional communications interface 710 coupled to computer 702, and a computer-program product including a tangible computer-readable storage medium 712 in or accessible to computer 702. Instructions stored on computer-readable storage medium 712 may direct system 700 to perform the methods and processes described herein. Computer 702 may include one or more processors 714 that communicate with a number of peripheral devices via a bus subsystem 716. These peripheral devices may include user output device(s) 706, user input device(s) 708, communications interface 710, and a storage subsystem, such as random-access memory (RAM) 718 and non-volatile storage drive 720 (e.g., disk drive, optical drive, solid state drive), which are forms of tangible computer-readable memory.

Computer-readable medium 712 may be loaded into random access memory 718, stored in non-volatile storage drive 720, or otherwise accessible to one or more components of computer 702. Each processor 714 may comprise a microprocessor, such as a microprocessor from Intel® or Advanced Micro Devices, Inc.®, or the like. To support computer-readable medium 712, the computer 702 runs an operating system that handles the communications between computer-readable medium 712 and the above-noted components, as well as the communications between the above-noted components in support of the computer-readable medium 712. Exemplary operating systems include Windows® or the like from Microsoft Corporation, MacOS from Apple, Solaris® from Sun Microsystems, LINUX, UNIX, and the like. In many embodiments and as described herein, the computer-program product may be an apparatus (e.g., a hard drive including case, read/write head, etc., a computer disc including case, a memory card including connector, case, etc.) that includes a computer-readable medium (e.g., a disk, a memory chip, etc.). In other embodiments, a computer-program product may comprise the instruction sets, or code modules, themselves, and be embodied on a computer-readable medium.

User input devices 708 include all possible types of devices and mechanisms to input information to computer system 702. These may include a keyboard, a keypad, a mouse, a scanner, a digital drawing pad, a touch screen incorporated into the display, audio input devices such as voice recognition systems, microphones, and other types of input devices. In various embodiments, user input devices 708 are typically embodied as a computer mouse, a trackball, a track pad, a joystick, wireless remote, a drawing tablet, a voice command system. User input devices 708 typically allow a user to select objects, icons, text and the like that appear on the monitor 704 via a command such as a click of a button or the like. User output devices 706 include all possible types of devices and mechanisms to output information from computer 702. These may include a display (e.g., monitor 704), printers, non-visual displays such as audio output devices, etc.

Communications interface 710 provides an interface to other communication networks and devices and may serve as an interface to receive data from and transmit data to other systems, WANs and/or the Internet, via a wired or wireless communication network 722. In addition, communications interface 710 can include an underwater radio for transmitting and receiving data in an underwater network. Embodiments of communications interface 710 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 710 may be coupled to a computer network, to a Fire Wire® bus, or the like. In other embodiments, communications interface 710 may be physically integrated on the motherboard of computer 702, and/or may be a software program, or the like.

RAM 718 and non-volatile storage drive 720 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 718 and non-volatile storage drive 720 may be configured to store the basic programming and data constructs that provide the functionality of various embodiments of the present invention, as described above.

Software instruction sets that provide the functionality of the present invention may be stored in computer-readable medium 712, RAM 718, and/or non-volatile storage drive 720. These instruction sets or code may be executed by the processor(s) 714. Computer-readable medium 712, RAM 718, and/or non-volatile storage drive 720 may also provide a repository to store data and data structures used in accordance with the present invention. RAM 718 and non-volatile storage drive 720 may include a number of memories including a main random-access memory (RAM) to store instructions and data during program execution and a read-only memory (ROM) in which fixed instructions are stored. RAM 718 and non-volatile storage drive 720 may include a file storage subsystem providing persistent (non-volatile) storage of program and/or data files. RAM 718 and non-volatile storage drive 720 may also include removable storage systems, such as removable flash memory.

Bus subsystem 716 provides a mechanism to allow the various components and subsystems of computer 702 communicate with each other as intended. Although bus subsystem 716 is shown schematically as a single bus, alternative embodiments of the bus subsystem may utilize multiple busses or communication paths within the computer 702.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, wireless channels, and/or various other storage mediums capable of storing that contain or carry instruction(s) and/or data.

### CONCLUSION

Whereas many alterations and modifications of the present invention will no doubt become apparent to a person of ordinary skill in the art after having read the foregoing description, it is to be understood that the particular embodiments shown and described by way of illustration are in no way intended to be considered limiting.

Moreover, the processes described above, as well as any other aspects of the disclosure, may each be implemented by software, but may also be implemented in hardware, firmware, or any combination of software, hardware, and firmware. Instructions for performing these processes may also be embodied as machine or computer readable code recorded on a machine or computer readable medium. In some embodiments, the computer readable medium may be a non-transitory computer readable medium. Examples of such a non-transitory computer readable medium include but are not limited to a read only memory, a random-access memory, a flash memory, a CDROM, a DVD, a magnetic tape, a removable memory card, and optical data storage devices. In other embodiments, the computer readable medium may be a transitory computer readable medium. In such embodiments, the transitory computer readable medium can be distributed over network coupled computer systems so that the computer readable code is stored and executed in a distributed fashion. For example, such a transitory computer readable medium may be communicated from one electronic device to another electronic device using any suitable communications protocol. Such a transitory computer readable medium may embody computer readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that any or each module of any one or more of any system, device, or server may be provided as a software construct, firmware construct, one or more hardware components, or a combination thereof, and may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules of any one or more of any system, device, or server are merely illustrative, and that the number, configuration, functionality, and interconnection of existing modules may be modified or omitted, additional modules may be added, and the interconnection of certain modules may be altered.

While there have been described systems, methods, and computer-readable media for enabling efficient control of a media application at a media electronic device by a user electronic device, it is to be understood that many changes may be made therein without departing from the spirit and scope of the disclosure. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the invention can be practiced by other than the described embodiments, which are presented for purposes of illustration rather than of limitation.

What is claimed is:

1. A method for generating synthetic samples for training a visual speech recognition (VSR) model, the method comprising:
obtaining a set of training data configured to train the VSR model, the set of training data including a series of samples, with each sample providing video of a subject and corresponding text specifying speech content (and audio in some cases);
deriving, for each sample included in the set of training data, a number of groups in which the sample corresponds;
identifying, for each group, whether the group is an under-represented group based on a determination of whether the group is associated with fewer samples than an amount of samples associated with other groups of a same group type;
generating, by a sample generation model, a plurality of synthetic samples, wherein the plurality of synthetic samples comprise features associated with one or more identified under-represented groups, and wherein the plurality of synthetic samples to be generated for each under-represented group is determined based on a difference between samples associated with the under-represented group and the samples that are associated with the other groups of the same group type; and
training the VSR model using the set of training data and the plurality of synthetic samples generated by the sample generation model, wherein the VSR is configured to derive speech content from a video input.

2. The method of claim 1, wherein each group is associated with a corresponding group type, wherein each group type relates to any of: a predicted age, gender, with/without beard or moustache, accent, ethnicity and/or other attributes of a subject depicted in each sample.

3. The method of claim 1, wherein deriving each group in which each sample corresponds further comprises:
processing each sample with any of an age estimation model, a gender classification model, and a cultural background prediction model to predict a series of attributes of the sample, wherein the series of attributes are used in deriving each group in which the sample corresponds.

4. The method of claim 1, wherein identifying whether the group is the under-represented group further includes:
performing a histogram analysis to determine each under-represented group as being associated with fewer samples than the amount of samples associated with other groups of the same group type.

5. The method of claim 1, wherein the sample generation model is a generative adversarial network (GAN) model.

6. The method of claim 5, wherein generating the plurality of synthetic samples further comprises:
implementing a random latent vector with any of a set of input data as an input to the GAN model for generating each synthetic sample.

7. The method of claim 6, wherein the set of input data comprises any of:
a face image and audio associated with a first group;
a mouth area image and the audio associated with the first group;
the face image and a natural language text associated with the first group;
the mouth area image and the natural language texts associated with the first group;
the face image and a text-audio pair associated with the first group; and
the mouth area image and the text-audio pair associated with the first group.

8. A computer-readable storage medium containing program instructions for a method being executed by an application, the application comprising code for one or more components that are called by the application during runtime, wherein execution of the program instructions by one or more processors of a computer system causes the one or more processors to perform steps comprising:
obtaining a set of training data configured to train a visual speech recognition (VSR) model;
deriving, for each sample included in the set of training data, a number of groups in which the sample corresponds;
identifying, for each group, whether the group is an under-represented group based on a determination of whether the group is associated with fewer samples than an amount of samples associated with other groups of a same group type;
generating, by a sample generation model, a plurality of synthetic samples, wherein a first synthetic sample is added to the plurality of synthetic samples:
and
training the VSR model using the set of training data and the plurality of synthetic samples generated by the sample generation model.

9. The computer-readable storage medium of claim 8, wherein the plurality of synthetic samples comprise features associated with one or more identified under-represented groups.

10. The computer-readable storage medium of claim 9, wherein the plurality of synthetic samples to be generated for each under-represented group is determined based on a difference between samples associated with the under-represented group and the samples that are associated with the other groups of the same group type.

11. The computer-readable storage medium of claim 8, wherein each group is associated with a corresponding group type, wherein each group type relates to any of: a predicted age, gender, cultural background, and/or native language of a subject depicted in each sample.

12. The computer-readable storage medium of claim 8, wherein deriving each group in which each sample corresponds further comprises:
processing each sample with any of an age estimation model, a gender classification model, and a cultural background prediction model to predict a series of attributes of the sample, wherein the series of attributes are used in deriving each group in which the sample corresponds.

13. The computer-readable storage medium of claim 8, wherein identifying whether the group is the under-represented group further includes:
performing a histogram analysis to determine each under-represented group as being associated with fewer samples than the amount of samples associated with other groups of the same group type.

14. The computer-readable storage medium of claim 8, wherein the sample generation model is a generative adversarial network (GAN) model.

15. A method comprising:
obtaining a set of training data configured to train a visual speech recognition (VSR) model, the set of training data including a series of samples, with each sample providing video of a subject and corresponding audio and/or text specifying speech content;
specifying a number of group types and, for each group type, a series of groups;
deriving, for each sample included in the set of training data, a number of groups in which the sample corresponds;
identifying, for each group, whether the group is an under-represented group based on a determination of whether the group is associated with fewer samples than an amount of samples associated with other groups of a same group type;
generating, by a generative adversarial network (GAN) model, a plurality of synthetic samples, wherein each synthetic sample is generated using a set of input data as an input, and wherein the plurality of synthetic samples comprise features associated with one or more identified under-represented groups; and
training the VSR model using the set of training data and the plurality of synthetic samples generated by the sample generation model, wherein the VSR is configured to derive speech content from a video input.

16. The method of claim 15, wherein the plurality of synthetic samples to be generated for each under-represented group is determined based on a difference between samples associated with the under-represented group and the samples that are associated with the other groups of the same group type.

17. The method of claim 15, wherein the set of input data comprise any of:
a face image and audio associated with a first group;
a mouth area image and the audio associated with the first group;
the face image and a natural language text associated with the first group;
the mouth area image and the natural language texts associated with the first group;
the face image and a text-audio pair associated with the first group; and
the mouth area image and the text-audio pair associated with the first group.

18. The method of claim 15, wherein identifying whether the group is the under-represented group further includes:
performing a histogram analysis to determine each under-represented group as being associated with fewer samples than the amount of samples associated with other groups of the same group type.
